(19) United States
(12) Patent Application Publication
(10) Pub. No.: US 2011/0188869 A1
(43) Pub. Date: Aug. 4, 2011

(54) IMAGE FORMING APPARATUS AND IMAGE FORMING METHOD

(75) Inventor: Tetsuya Nakamura, Tokyo-to (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/006,561

(22) Filed: Jan. 14, 2011

Related U.S. Application Data
(60) Provisional application No. 61/300,861, filed on Feb. 3, 2010.

(51) Int. Cl. G03G 15/06; G03G 13/01; G03G 21/00

(52) U.S. Cl. 399/38; 430/42.1; 399/359

(57) ABSTRACT

According to one embodiment, a cleaner-less mechanism is provided only in a black image forming unit, and a cleaning apparatus is provided in a color image forming unit. Otherwise, when an image adjustment function is executed, the number of operations of forming an image adjustment pattern corresponding only to a black developing agent is reduced.

### CROSS-REFERENCE TO RELATED APPLICATIONS

This application is based upon and claims the benefit of priority from U.S. Provisional Application No. 61/300,861, filed on Feb. 3, 2010; the entire contents of which are incorporated herein by reference.

### FIELD

Embodiments described herein relate generally to an image forming apparatus and an image forming method.

### BACKGROUND

In general, as a color image forming apparatus using an electro-photographic method, an image forming system of a so-called quadruple tandem-type is used in which drums that hold toner developed by developing apparatuses that develop four colors of toner including yellow, magenta, cyan, and black, and form an image are disposed in series, and a color image is formed by overlapping images of the respective colors. This type is suitable for printing color images at high speed; however, there are problems in that color developing devices or drums have to be operated during printing of the black toner only, and a cleaner needs to be provided in order to prevent color mixing that occurs as the four colors are arranged in series such that an image forming system that reuses transfer residues cannot be used. Therefore, the amount of the black toner consumed is higher than that of a monochrome image forming apparatus, so that high costs are incurred during so-called monochrome printing. On the other hand, as a countermeasure against this, a system is developed to separate the drums used for colors from an intermediate transfer body used for overlapping the colors and suspend driving of the color developing devices and drums; however, compared to a dedicated monochrome printing system, print costs increase by the amount of toner that remains during sheet transfer and is thus wasted.

### BRIEF DESCRIPTION OF THE DRAWINGS

FIG. 1 is an exemplary view showing the configuration of an image forming apparatus according to first and second embodiments;

FIG. 2 is an exemplary view showing the internal structure of an image forming apparatus according to third and fourth embodiments;

FIG. 3 is a block diagram showing a control system of the image forming apparatus 300 according to the third and fourth embodiments;

FIG. 4 is a flowchart showing operations of an image adjustment function according to the third and fourth embodiments;

FIG. 5 is an exemplary view showing an image adjustment pattern according to the third and fourth embodiments; and

FIG. 6 is an exemplary view showing another image adjustment pattern according to the third and fourth embodiments.

### DETAILED DESCRIPTION

An image forming apparatus according to a first embodiment includes: a first image forming unit including a first image carrier that forms a black developing agent image, a first developing unit that is provided to oppose the first image carrier to form the black developing agent image on the first image carrier using a black developing agent, and a first transfer unit that transfers the black developing agent image onto a target transfer body; and a second image forming unit including a second image carrier that forms a color developing agent image, a second developing unit that is provided to oppose the second image carrier to form the color developing agent image on the second image carrier using a color developing agent, a second transfer unit that transfers the color developing agent image onto the target transfer body, and a cleaning member to remove the color developing agent image remaining on the second image carrier after the transfer.

In the image forming apparatus according to the first embodiment, the second image forming unit has the cleaning member to remove the color developing agent image remaining on the image carrier; however, the first image forming unit has a cleaner-less mechanism to reuse the black developing agent remaining on the image carrier.

Accordingly, the amount of the black developing agent consumed can be reduced.

The color developing agent may be selected from among, for example, a yellow developing agent, a cyan developing agent, and a magenta developing agent.

Moreover, a third image forming unit used for forming a color developing agent image for a different color from the color developing agent used by the second image forming unit, and a fourth image forming unit used for forming a color developing agent image for a different color from the color developing agents used by the second and third image forming units may be provided. At this time, the third and fourth image forming units are respectively provided with cleaning members, and only the first image forming unit may be provided with the cleaner-less mechanism.

The first image forming unit may be provided at the start of the order of image transfer. As the order of, for example, K (black), C (cyan), M (magenta), and Y (yellow) is determined to provide the cleaner-less mechanism at the start of the order of printing, it is possible to completely avoid a problem of color mixing. Otherwise, for example, the order of Y, M, C, and K may be determined to provide the first image forming unit at the end of the order of image transfer. In this case, although color mixing of Y/M/C occurs in actual use; however, since black is a color generated by overlapping the other colors, there is no significant problem.

A mechanism that separates the first developing unit from the first image carrier during color image formation may be provided. Accordingly, the amount of the black developing agent consumed at the start of an image formation operation or at the suspension thereof can further be reduced.

An image forming method according to a second embodiment includes: a first image formation process of forming a first electrostatic latent image on a first image carrier to form a black developing agent image, developing the first electrostatic latent image by supplying a black developing agent from a first developing unit, forming the black developing agent image on the first image carrier, and transferring the black developing agent image onto a target transfer body using a first transfer unit; and a second image formation process of forming a second electrostatic latent image on a second image carrier to form a color developing agent image, forming the color developing agent image on the second image carrier by supplying a color developing agent from a second developing unit, transferring the color developing agent image onto the target transfer body using a second transfer unit, and removing the color developing agent remaining on the second image carrier after the transfer using a cleaning member.

According to the second embodiment, in the second image formation process, the color developing agent remaining on the image carrier after the transfer is removed using the cleaning member; however, in the first image formation process, the black developing agent remaining on the image carrier after the transfer is reused by a cleaner-less mechanism.

Accordingly, the amount of the black developing agent consumed can be reduced.

An image forming apparatus according to a third embodiment includes: a first image forming unit including a first image carrier that forms a black developing agent image, a first developing unit that is provided to oppose the first image carrier to form the black developing agent image on the first image carrier using a black developing agent, and a first transfer unit that transfers the black developing agent image onto a target transfer body; and a second image forming unit including a second image carrier that forms a color developing agent image, a second developing unit that is provided to oppose the second image carrier to form the color developing agent image on the second image carrier using a color developing agent, and a second transfer unit that transfers the color developing agent image onto the target transfer body.

The image forming apparatus according to the third embodiment includes an image adjustment function unit and an image adjustment function control unit.

The image adjustment function unit forms an image adjustment pattern using the black developing agent and forms an image adjustment pattern using the color developing agent, and adjusts an image formation condition of the first image forming unit and an image formation condition of the second image forming unit on the basis of a detection result of such pattern images; and

The image adjustment function control unit controls a pattern image formation condition so that the amount of the black developing agent consumed for pattern formation is smaller than an amount of the color developing agent consumed for the pattern formation.

Accordingly, the amount of the black developing agent consumed can be reduced.

According to the third and fourth embodiments, the number of operations of the image adjustment function of the black image formation in the image adjustment function for color printing is reduced compared to the number of operations of the image adjustment function of the color image formation, thereby reducing the amount of the black developing agent used during non-printing.

In addition, as the black image adjustment pattern, a tone pattern or a pattern subjected to binary image processing may be used.

The number of operations of forming the black image adjustment pattern may be set to zero.

As the image processing using the black developing agent uses the binary image processing, density fluctuation can be reduced, so that when this effect is combined, the amount of toner used can further be reduced. Since a combination of three colors of Y/M/C is originally predominant, density fluctuation of black is not a significant problem. Accordingly, image process switching is not necessary. Therefore, when the binary image processing is used, it is possible to set the number of image adjustment functions to zero.

The mechanism that separates the first developing unit from the first image carrier during color image formation may be provided.

Accordingly, the first developing unit abuts the first image carrier when black image formation is performed, and the first developing unit is separated from the first image carrier when the black image formation is terminated, thereby reducing the amount of the black developing agent consumed at the start of the image formation operation or at the suspension thereof.

In the image forming apparatus according to the third embodiment, as in the image forming apparatus according to the first embodiment, the first image forming unit may have a cleaner-less mechanism to reuse the black developing agent remaining on the image carrier, and the second image forming unit may have a cleaning member to remove the color developing agent image remaining on the image carrier after the transfer.

The image forming method according to the fourth embodiment is a method of performing image formation using the image forming apparatus according to the third embodiment, and includes: a first image formation process of forming a first electrostatic latent image on a first image carrier to form a black developing agent image, developing the first electrostatic latent image by supplying a black developing agent from a first developing unit, forming the black developing agent image on the first image carrier, and transferring the black developing agent image onto a target transfer body using a first transfer unit; and a second image formation process of forming a second electrostatic latent image on a second image carrier to form a color developing, agent image, forming the color developing agent image on the second image carrier by supplying a color developing agent from a second developing unit, and transferring the color developing agent image onto the target transfer body using a second transfer unit.

In the image forming method according to the fourth embodiment, an image adjustment function unit forms an image adjustment pattern using the black developing agent and forms an image adjustment pattern using the color developing agent, and adjusts an image formation condition of the first image forming unit and an image formation condition of the second image forming unit on the basis of a detection result of such pattern images; and an image adjustment function control unit controls a pattern image formation condition so that the amount of the black developing agent consumed for pattern formation is smaller than the amount of the color developing agent consumed for the pattern formation. Moreover, the number of operations of forming the black image adjustment pattern is reduced to be smaller than the number of operations of forming the color image adjustment pattern.

Accordingly, the amount of the black developing agent consumed can be reduced.

Hereinafter, embodiments will be described in detail with reference to the accompanying drawings.

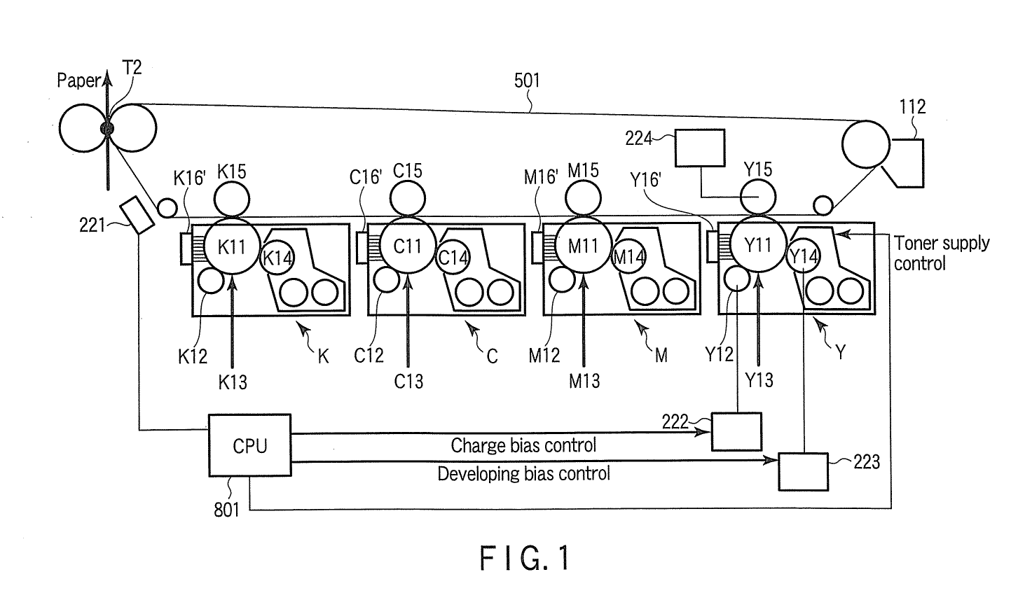

FIG. 1 is a diagram showing an example of the configuration of an image forming apparatus according to first and second embodiments.

As shown in FIG. 1, the image forming apparatus according to the first and second embodiments employs an intermediate transfer type using an intermediate transfer belt as an intermediate transfer body. In addition, the image forming apparatus according to the first and second embodiments includes four process units K to Y for black, cyan, magenta, and yellow, and has a quadruple tandem configuration in which the process units (image forming stations) are arranged along a movement direction of a belt surface of the intermediate transfer belt.

Each of the process units K to Y will be described in detail.

First, the process unit Y includes a photoconductor Y11, a cleaning member Y16, a charge roller Y12, and a developing device (developing unit) having a developing roller 14. In addition, the process unit Y at least has the photoconductor Y11 formed integrally with at least either of the charge roller Y12 and the developing device so as to be attached to or detached from the main body of the image forming apparatus.

The photoconductor Y11 according to this embodiment may employ well-known materials such as OPC (organic photoconductors) or amorphous silicon (a-Si). Here, OPC is used.

As a charging unit, for example, scorotron charger or a charge roller is used. In this embodiment, the charge roller Y12 is employed, and an AC bias of pp2 kV (2 kHz) is applied to DC −650 V by a charging bias voltage applying unit 222 controlled by a CPU 801 to charge the OPC at −650 V.

An exposure device Y13 uses a laser or an LED as a light source. The exposure device Y13 uses, for example, a semiconductor laser having a wavelength of 700 nm, and reduces a photoconductive potential of an exposed portion. An exposure amount at this time may be set to about 4 times the exposure amount of the photoconductor reduced by half.

The image forming apparatus according to this embodiment employs a two-component developing type using two-component developing agents made of toner and carrier, a bristle is formed by the carrier on the developing roller (magnetic roller) Y14 including a permanent magnet, and a DC bias, a DC+AC bias, or the like is applied between the brush and the photoconductor surface by a developing bias voltage applying unit 223 controlled by the CPU 801, thereby performing development.

As an example of a method of applying a developing bias voltage, AC of pp2 kV (6 kHz) is superimposed on DC of −500 V. However, various attempts to enhance image quality such as changing a square wave or a Duty ratio of the AC bias are made.

Under such conditions, for example, the exposure amount is set to about 1.3 times the exposure amount of the photoconductor Y11 reduced by half, so that the potential of the photoconductor after exposure becomes about −250 V, and a difference between the potential of the photoconductor and the developing bias at a non-image portion (background contrast) becomes 150 V. Here, a difference between the developing bias and the potential after the exposure (developing contrast) becomes 250 V.

Subsequently, a toner image developed on the photoconductor under the conditions is transferred onto an intermediate transfer belt 501 by a transfer unit. The intermediate transfer belt 501 has semiconductivity, and is made of a resin with a thickness of 50 to 2,000 μm, rubber, or a laminated member thereof. As a transfer member applied with a transfer bias is in contact with a surface of the intermediate transfer belt 501 on the side opposite to the photoconductor Y11, a transfer electric field is applied to a transfer nip portion where the photoconductor Y11 and the intermediate transfer belt 501 are in contact with each other or to the periphery thereof.

According to this embodiment, a transfer roller Y15 using a conductive sponge with a volume resistance of 10×10⁵ to 10×10⁸ Ωcm is brought into contact with the rear surface of the intermediate transfer belt 501, and DC of 300 V to 3,000 V is applied thereto by a transfer bias voltage applying unit 224 controlled by the CPU 801, so that the toner image on the photoconductor is transferred onto the intermediate transfer belt 501. In addition, as the toner images are overlapped and transferred onto the intermediate transfer belt 501 by the process units K to Y, a full color image is formed and is then transferred onto paper which is a target transfer body at a secondary transfer position T2, and the image is heated and fixed by a fixing device (not shown), thereby forming a final image.

In such a configuration, there is a single intermediate transfer body, and two operations including a primary transfer operation of transferring the toner image onto the intermediate transfer belt 501 from the photoconductor Y11 and a secondary transfer operation of, after the toner images for four colors are overlapped to be transferred on the intermediate transfer belt 501 in the primary transfer operation, collectively transferring the overlapped toner images on the paper, etc.

Besides, a direct transfer type (a paper carrying transfer belt other than the intermediate transfer body) in which overlap transfer of a plurality of colors from a photoconductor is directly performed on paper, a type in which toner images are transferred and carried via a plurality of intermediate transfer bodies, and the like are proposed. However, the overlap transfer on the paper is unstable, and the transfer operation inherently causes image quality deterioration, so that in consideration of a reduction in the number of transfer operations as many as possible, an apparatus with an object of high image quality may employ a single intermediate transfer body as described above.

In addition, the process units Y, M, and C are respectively provided with the cleaning members Y16, M16, and C16 for removing the toner remaining on the photoconductor, and as needed, a neutralization process is performed. Then, a charging operation is performed again.

In contrast, the process unit K may be provided with a disturbing brush K16′ so as to reuse the toner remaining on the photoconductor.

In addition, the process unit K may be provided with, although not shown in the figure, for example, a mechanism for separating the developing device including the developing roller K14 from the photoconductor K11. In this mechanism, when the process units Y, M, and C are involved in image formation and the process unit K is not involved in the image formation, the developing device can be separated from the photoconductor K11.

Moreover, the process units K to Y according to the first and second embodiments have the same basic configurations except for the cleaning members Y16, M16, and C16 which are different from the disturbing brush K16′, so that the configuration of the yellow process unit Y will be described in detail, and detailed description of the other process units K, C, and M will be omitted.

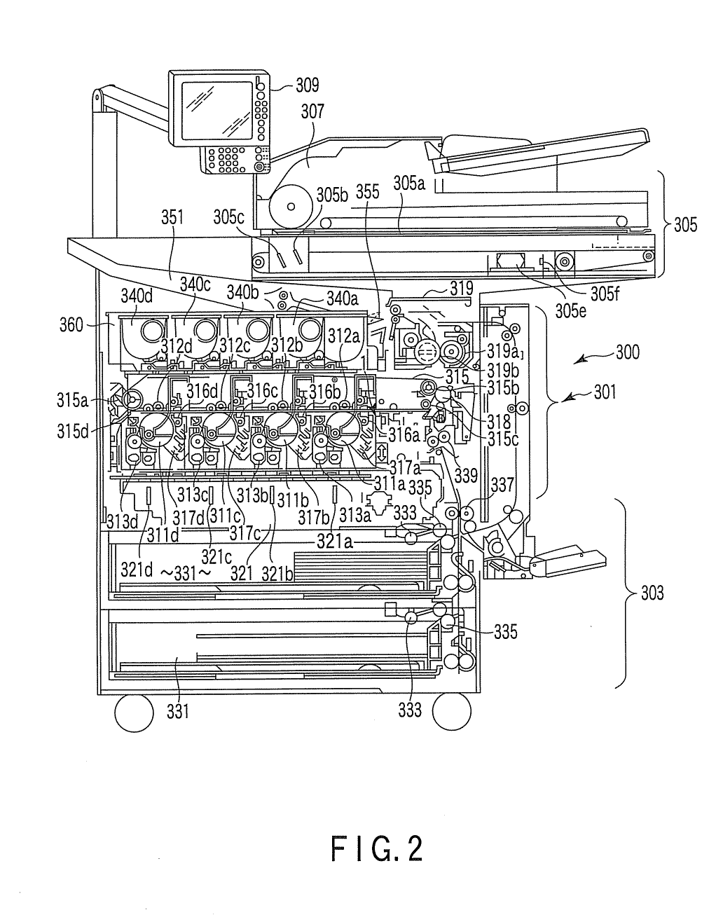

FIG. 2 is a diagram schematically showing the internal structure of an image forming apparatus 300 according to third and fourth embodiments in front view. First, the structure of an image reading unit 305 is described. The image reading unit 305 includes a transparent platen glass 305a on which an original document is placed, a light source 305b that illuminates the original document, and a reflective mirror 305c that reflects light reflected from the original document. In addition, the light source 305b and the reflective mirror 305c are formed integrally with a document illumination unit 305d which is movable in a horizontal direction. The light reflected by the document illumination unit 305d is received via an imaging lens 305e disposed on a light path.

Next, the configuration of an image forming unit 301 is described. On an upper side of the image forming unit 301, toner cartridges 340a, 340b, 340c, and 340d are arranged in parallel. The toner cartridges 340a, 340b, 340c, and 340d are attachable to and detachable from a cartridge holding mechanism 360 provided on a front surface side of the image forming unit 301. The toner cartridges 340a, 340b, 340c, and 340d supply toner of yellow (Y), magenta (M), cyan (C), and black (K). In addition, in the vicinities of the toner cartridges 340a, 340b, 340c, and 340d, toner sensors 370a, 370b, 370c, and 370d (not shown) are respectively provided to detect the amount of residual toner of the corresponding colors.

The image forming unit 301 includes first to fourth photoreceptor drums 311a to 311d as image holding bodies that hold latent images, developing apparatuses 313a to 313d that develop the latent images formed on the photoreceptor drums 311a to 311d, an intermediate transfer belt 315 that holds images of developing agents developed on the photoreceptor drums 311a to 311d in an overlapping state, cleaners 316a to 316d that respectively remove the toner remaining on the photoreceptor drums 311a to 311d from the photoreceptor drums 311a to 311d, and chargers 317a to 317d that identically charge the photoreceptor drums 311a to 311d.

In addition, the image forming unit 301 includes a transfer apparatus 318 that transfers the images of the developing agents overlapping on the intermediate transfer belt 315 onto an output medium in a sheet type such as a general sheet of paper which is not subjected to specific processing, or an OHP sheet which is a transparent resin sheet, and a fixing apparatus 319 that fixes the images of the developing agents transferred onto a target transfer medium to an output medium. In addition, the image forming unit 301 includes an exposure apparatus 321 having LEDs 321a to 321d that form latent images by allowing laser light modulated according to image data for writing to illuminate the photoreceptor drums 311a to 311d, and the like.

The intermediate transfer belt 315 is stretched by a driving roll 315a that rotates the intermediate transfer belt 315, a tension roll 315b provided to maintain a constant tensile force applied to the intermediate transfer belt 315 and a backup roll 315c for secondary transfer.

At points (primary transfer portions) where the intermediate transfer belt 315 abuts the photoreceptor drums 311a to 311d, on the rear surface side of the intermediate transfer belt 315, primary transfer rolls 312a to 312d are disposed which come in pressing contact with the photoreceptor drums 311a to 311d via the intermediate transfer belt 315.

The transfer apparatus 318 is disposed to abut the intermediate transfer belt 315 on a toner holding surface side (outer side) of the intermediate transfer belt 315 (secondary transfer portion), and opposes the backup roll 315c disposed on the rear surface side (inner side) of the intermediate transfer belt 315.

In addition, at a point where the driving roll 315a is provided on the intermediate transfer belt 315, a belt cleaner 315d is disposed to abut the intermediate transfer belt 315 at a position opposing the driving roll 315a while fitting the intermediate transfer belt 315.

In addition, an LED light source 314a and an optical sensor 314b that detect the amount of reflected light of a toner pattern formed on the intermediate transfer belt 315 are disposed between the fourth station of the primary transfer portions and the second transfer portion.

The first to fourth photoreceptor drums 311a to 311d respectively hold electrostatic images (latent images) for colors to be visualized (developed) by the developing apparatuses 313a to 313d which accommodate the toner of the arbitrary colors including yellow (Y), magenta (M), cyan (C), and black (K). However, the order of arrangement thereof is prescribed as a predetermined order according to an image forming process and characteristics of the toner (developing agents). The intermediate transfer belt 315 holds the developing agent images of the colors formed by the first to fourth photoreceptor drums 311a to 311d and the corresponding developing apparatuses 313a to 313d in the formation order.

A sheet feeding unit 303 feeds the output medium to the transfer apparatus 318 at a predetermined timing when the images of the developing agents are transferred by the transferring apparatus 318.

Cassettes set by a plurality of cassette slots 331 accommodate output media with arbitrary sizes. In response to an image forming operation, a pickup roller 333 picks up the output medium. The size of the output medium corresponds to the size of the image of the developing agent formed by the image forming unit 301. A separation mechanism 335 prevents the pickup roller 333 from picking up two or more output media from the cassette. A plurality of carrying rollers 337 carries the output medium limited to one sheet by the separation mechanism 335 toward an aligning roller 339. The aligning roller 339 sends the output medium to a transfer position at which the transfer apparatus 318 and the intermediate transfer belt 315 come in contact with each other in synchronization with a timing at which the transfer apparatus 318 transfers the images of the developing agents from the intermediate transfer belt 315. Moreover, the cassette slots 331, the pickup roller 333, and the separation mechanism 335 may be prepared to be plural in number as needed, and the cassette is arbitrarily attachable to a different slot.

The output medium on which the image information is fixed by the fixing apparatus 319 is discharged to a paper discharge tray 351 defined on the image forming unit main body 301 on a lateral side of the image reading unit 305. Here, the fixing apparatus 319 has a fixing roller 319a and a pressurizing roller 319b on the downstream side of the paper discharge direction. The image information is fixed to the output medium on which the images of the developing agents are transferred as the images of the developing agents are fused by the fixing roller 319a heated to 180° C. and the pressurizing roller 319b.

In addition, the image forming apparatus 300 has a lateral paper discharge tray 359 on a side surface of the image forming unit 301. The output medium discharged from the fixing apparatus 319 is guided to the lateral paper discharge tray 359 via an interruption carrying unit 371 connected to a switching unit 355.

In addition, the photoreceptor drum 311d and the developing apparatus 313d may be provided with, although not shown in the figure, a mechanism for separating the photoreceptor drum 311d and the developing apparatus 313d from each other. In this mechanism, when the other photoreceptor drums 311a to 311c and the developing apparatuses 313a to 313c are involved in image formation and the photoreceptor drum 311d and the developing apparatus 313d are not involved in the image formation, the photoreceptor drum 311d and the developing apparatus 313d may be separated from each other.

Moreover, the photoreceptor drums 311a to 311c are respectively provided with cleaning members for removing the toner remaining on the photoconductors after the transfer, and as needed, a neutralization process is performed. Then, the toner may be supplied again for charging.

On the other hand, the photoreceptor drum 311d may be provided with a disturbing brush so as to reuse the toner remaining on the photoconductor.

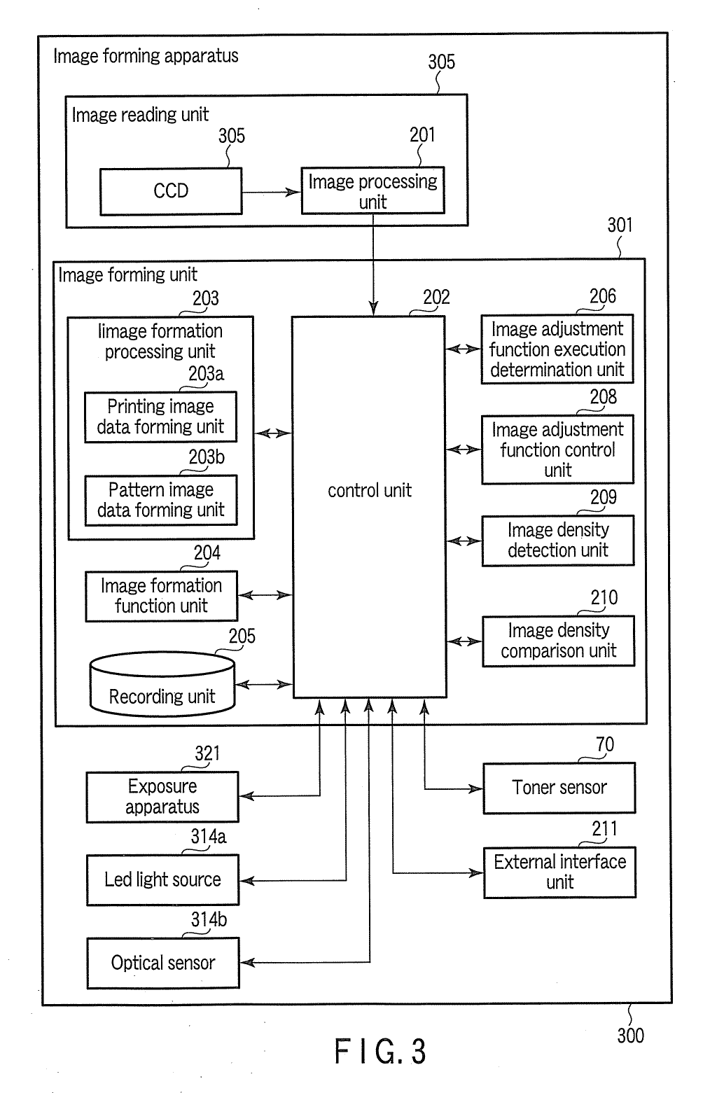

FIG. 3 is a block diagram showing a control system of the image forming apparatus 300 according to this embodiment. An image processing unit 201 is provided on the image reading unit 305 side. The image processing unit 201 converts an output signal from reflected light received by a CCD 305f into image data of yellow (Y), magenta (M), cyan (C), and black (K) and performs data processing such as density correction thereon to be output as image data for writing.

In addition, the image forming unit 301 includes a control unit 202, an image formation processing unit 203, an image formation function unit 204, a recording unit 205, an image adjustment function execution determination unit 206, an image adjustment function control unit 208, an image density detection unit 209, and an image density comparison unit 210.

The control unit 202 controls LEDs 321a to 321d of the exposure apparatus 321 that allow laser light modulated according to the image data for writing of the image processing unit 201 to illuminate the photoreceptor drums 311a to 311d. In addition, the control unit 202 determines that re-adjustment is needed, for example, when the number of color image printing copies reaches a predetermined threshold value and executes the image adjustment function.

The image formation processing unit 203 forms the images (color images/monochrome images) of the developing agents transferred on the intermediate transfer belt 315 and outputs them to the exposure apparatus 321.

The image formation function unit 204 forms an image adjustment pattern using the black developing agent and an image adjustment pattern using the color developing agents, and on the basis of a detection result of the pattern images, adjusts an image formation condition of a first image forming unit and an image formation condition of a second image forming unit.

The recording unit 205 records the number of color image printing copies of the image formed by the image formation processing unit 203 and a YMC pattern printing reference value which is an execution determination reference of formation of the image adjustment pattern. If the image adjustment function is regularly performed, the YMC pattern printing reference value of the color image may be set to, for example, 500 counts.

The image adjustment function execution determination unit 206 determines whether or not execution of the image adjustment function is needed by comparing the number of image printing copies to the upper limit of the number of image printing copies.

The image adjustment function control unit 208 controls the pattern image formation condition so that the amount of the black developing agent consumed for the pattern formation is smaller than the amount of the color developing agent consumed for the pattern formation.

The image density detection unit 209 calculates the image density of the image adjustment pattern formed on the intermediate transfer belt 315 during the execution of the image adjustment function. In addition, the image density detection unit 209 receives the reflected light of the light illuminated on the image adjustment pattern on the intermediate transfer belt 315 by the LED light source 314a through the optical sensor 314b, and calculates the pattern image density from the reflectance.

The image density comparison unit 210 compares the pattern image density calculated by the image density detection unit 209 to a predetermined target density and outputs the comparison result thereof to the control unit 202. The control unit 202 changes the image formation condition on the basis of the comparison result of the image adjustment pattern.

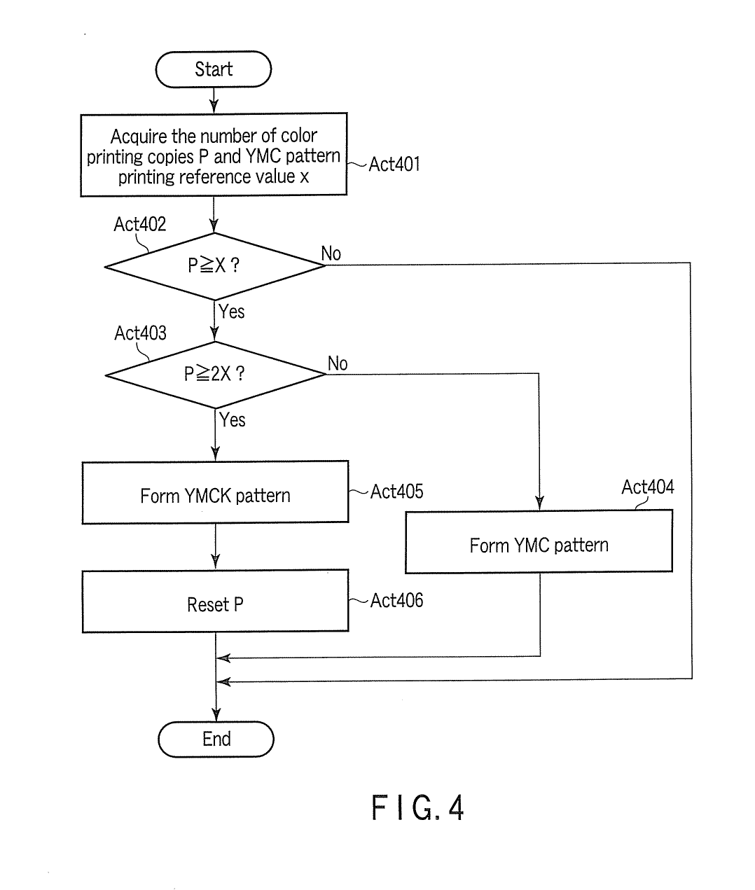

Here, operations of the image adjustment function according to this embodiment will be described with reference to a flowchart shown in FIG. 4.

In Act 401, the image adjustment function execution determination unit 206 acquires the number of color printing copies P and the YMC pattern printing reference value X from the recording unit 205.

In Act 402, the image adjustment function execution determination unit 206 determines whether or not the number of color printing copies P exceeds the YMC pattern printing reference value X. Here, the image adjustment function execution determination unit 206 proceeds to Act 403 if it is determined the number of color printing copies P is equal to or greater than the YMC pattern printing reference value X (Yes in Act 402). Contrary to this, if it is determined that the number of color printing copies P is smaller than the YMC pattern printing reference value X (No in Act 402), the image adjustment function execution determination unit 206 terminates the processing.

In Act 403, the image adjustment function execution determination unit 206 determines whether or not the number of color printing copies P exceeds a YMCK pattern printing reference value, for example, 2X. Here, if it is determined that the number of color printing copies P is equal to or greater than the YMCK pattern printing reference value 2X (Yes in Act 403), the image adjustment function execution determination unit 206 proceeds to Act 405, and forms patterns of the four colors including YMCK on the intermediate transfer body as the image adjustment patterns.

Subsequently, in Act 406, the number of color printing copies P is reset.

Contrary to this, if it is determined that the number of color printing copies P is smaller than the YMCK pattern printing reference value 2X (No in Act 403) by the image adjustment function execution determination unit 206 proceeds to Act 404, the black pattern of the image adjustment pattern is not formed, and the pattern of the three colors including YMC is formed on the intermediate transfer body.

During the series of operations, at one of two times the image adjustment function execution, the black pattern is formed as well as the YMC pattern.

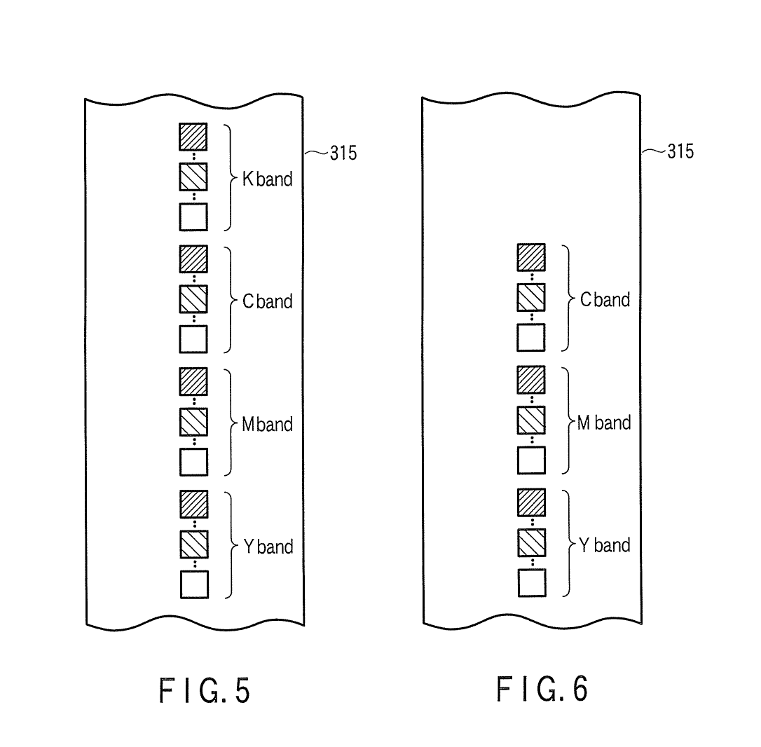

FIG. 5 illustrates an example of a tone pattern formed on the intermediate transfer belt 315 during the execution of the image adjustment function. Here, a band of 16 tone pattern patches of each of yellow (Y), magenta (M), cyan (C), and black (K) is formed on the intermediate transfer belt 315. FIG. 6 illustrates a case where the black tone pattern is not formed. Here, a band of 16 tone pattern patches of each of only yellow (Y), magenta (M), and cyan (C) is formed on the intermediate transfer belt 315.

In this manner, according to the first to fourth embodiments, by reducing the amount of the black developing agent consumed, cost for monochrome printing performed in the color image forming apparatus can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a first image forming unit including a first image carrier that forms a black developing agent image, a first developing unit that is provided to oppose the first image carrier to form the black developing agent image on the first image carrier using a black developing agent, a first transfer unit that transfers the black developing agent image onto a target transfer body, and a cleaner-less mechanism to reuse the black developing agent remaining on the image carrier; and
a second image forming unit including a second image carrier that forms a color developing agent image, a second developing unit that is provided to oppose the second image carrier to form the color developing agent image on the second image carrier using a color developing agent, a second transfer unit that transfers the color developing agent image onto the target transfer body, and a cleaning member that removes the color developing agent image remaining on the second image carrier after the transfer.

2. The apparatus according to claim 1, wherein the first image forming unit is provided at the start of the order of image transfer.

3. The apparatus according to claim 1, wherein the first image forming unit is provided at the end of the order of image transfer.

4. The apparatus according to claim 1, further comprising a mechanism that separates the first developing unit from the first image carrier during color image formation.

5. An image forming method comprising:
a first image formation process of forming a first electrostatic latent image on a first image carrier to form a black developing agent image, developing the first electrostatic latent image by supplying a black developing agent from a first developing unit, forming the black developing agent image on the first image carrier, transferring the black developing agent image onto a target transfer body using a first transfer unit and a cleaner-less mechanism to reuse the black developing agent remaining on the second image carrier after the transfer; and
a second image formation process of forming a second electrostatic latent image on a second image carrier to form a color developing agent image, forming the color developing agent image on the second image carrier by supplying a color developing agent from a second developing unit, transferring the color developing agent image onto the target transfer body using a second transfer unit, and removing the color developing agent remaining on the second image carrier after the transfer using a cleaning member.

6. The method according to claim 5, wherein the first image formation process is performed at the start of the order of image transfer.

7. The method according to claim 5, wherein the first image formation process is performed at the end of the order of image transfer.

8. The method according to claim 5, further comprising separating the first developing unit from the first image carrier during color image formation.

9. An image forming apparatus comprising:
a first image forming unit including a first image carrier that forms a black developing agent image, a first developing unit that is provided to oppose the first image carrier to form the black developing agent image on the first image carrier using a black developing agent, and a first transfer unit that transfers the black developing agent image onto a target transfer body;
a second image forming unit including a second image carrier that forms a color developing agent image, a second developing unit that is provided to oppose the second image carrier to form the color developing agent image on the second image carrier using a color developing agent, and a second transfer unit that transfers the color developing agent image onto the target transfer body;
an image adjustment function unit that forms an image adjustment pattern using the black developing agent and forms an image adjustment pattern using the color developing agent, and adjusts an image formation condition of the first image forming unit and an image formation condition of the second image forming unit on the basis of a detection result of such pattern images; and
an image adjustment function control unit that controls a pattern image formation condition so that an amount of the black developing agent consumed for pattern formation is smaller than an amount of the color developing agent consumed for the pattern formation.

10. The apparatus according to claim 9, wherein the number of operations of forming the black image adjustment pattern is set to zero.

11. The apparatus according to claim 9, wherein the black image adjustment pattern is subjected to binary image processing.

12. The apparatus according to claim 9, further comprising a mechanism that separates the first developing unit from the first image carrier during color image formation.

13. The apparatus according to claim 9,
wherein the first image forming unit has a cleaner-less mechanism to reuse the black developing agent remaining on the image carrier, and
the second image forming unit has a cleaning member to remove the color developing agent image remaining on the image carrier after the transfer.

14. An image forming method comprising:
a first image formation process of forming a first electrostatic latent image on a first image carrier to form a black developing agent image, developing the first electrostatic latent image by supplying a black developing agent from a first developing unit, forming the black developing agent image on the first image carrier, and transferring the black developing agent image onto a target transfer body using a first transfer unit; and
a second image formation process of forming a second electrostatic latent image on a second image carrier to form a color developing agent image, forming the color developing agent image on the second image carrier by supplying a color developing agent from a second developing unit, and transferring the color developing agent image onto the target transfer body using a second transfer unit,
wherein the number of printing copies of a final image including at least one of the black developing agent image and the color developing agent image is measured by an image printing copy counting unit,
whenever the number of printing copies reaches a reference value, only a color image adjustment pattern or both the color image adjustment pattern and a black image adjustment pattern are formed to reduce the number of operations of forming the black image adjustment pattern to be smaller than the number of operations of forming the color image adjustment pattern by an image adjustment function control unit, and
an image formation condition is changed by a control unit on the basis of the image adjustment pattern.

15. The method according to claim 14, wherein the number of operations of forming the black image adjustment pattern is set to zero.

16. The method according to claim 14, wherein the black image adjustment pattern is subjected to binary image processing.

17. The method according to claim 14, wherein the first developing unit is separated from the first image carrier during color image formation.

18. The method according to claim 14,
wherein the first image forming unit has a cleaner-less mechanism to reuse the black developing agent remaining on the image carrier, and
the second image forming unit has a cleaning member to remove the color developing agent image remaining on the image carrier after the transfer.
